(19) United States
(12) Patent Application Publication
(10) Pub. No.: US 2025/0047346 A1
(43) Pub. Date: Feb. 6, 2025

(54) COMMUNICATIONS NODES AND METHODS FOR PROPRIETARY MACHINE LEARNING-BASED CSI REPORTING

(71) Applicant: Telefonaktiebolaget LM Ericsson (publ), Stockholm (SE)

(72) Inventors: Roy TIMO, Kungsängen (SE); Mattias FRENNE, Uppsala (SE); Lars LINDBOM, Karlstad (SE)

(21) Appl. No.: 18/718,275

(22) PCT Filed: Oct. 25, 2022
(86) PCT No.: PCT/SE2022/050972

§ 371 Date: Jun. 10, 2024

Related U.S. Application Data
(60) Provisional application No. 63/265,418, filed on Dec. 15, 2021.

(51) Int. Cl. H04B 7/06; H04W 24/02

(52) U.S. Cl. CPC H04B 7/0626; H04W 24/02

(57) ABSTRACT

Providing channel state information, CSI, in a wireless communications network by a first node to a second node. The first node has access to one or more trained Neural Network, NN,-based Auto Encoder, AE,-encoder models for encoding the CSI and the second node has access to one or more trained NN-based AE-decoder models for decoding the CSI provided by the first node. The method includes receiving, from the second node, an indication of an NN-based AE-decoder model out of the one or more trained models; selecting a trained model out of the one or more trained models to use for the NN-based AE-encoder based on the received indication of the NN-based AE-decoder model such that the selected trained model is compatible with the indicated NN-based AE-decoder model; and transmitting (604) the CSI to the second node based on output from the selected trained model.

### TECHNICAL FIELD

The embodiments herein relate to communications nodes and methods for proprietary Machine Learning-based CSI reporting. A corresponding computer program and a computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas. Each service area or cell area may provide radio coverage via a beam or a beam group. Each service area or cell area is typically served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to RNCs used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn is connected to a network node 106. The access nodes 103-104 are part of the radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGW). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 corresponds typically to an 5G NodeB (gNB) and the network node 106 corresponds typically to either an Access and Mobility Management Function (AMF) and/or a User Plane Function (UPF). The gNB is part of the radio access network 10, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs may also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

NR uses Orthogonal Frequency Division Multiplexing (OFDM) with configurable bandwidths and subcarrier spacing to efficiently support a diverse set of use-cases and deployment scenarios. With respect to LTE, NR improves deployment flexibility, user throughputs, latency, and reliability. The throughput performance gains are enabled, in part, by enhanced support for Multi-User Multiple-Input Multiple-Output (MU-MIMO) transmission strategies, where two or more UEs receives data on the same time frequency resources, i.e., by spatially separated transmissions.

A MU-MIMO transmission strategy will now be illustrated based on FIG. 2. FIG. 2 illustrates an example transmission and reception chain for MU-MIMO operations. Note that the order of modulation and precoding, or demodulation and combining respectively, may differ depending on the implementation of MU-MIMO transmission.

A multi-antenna base station with N_{TX} antenna ports is simultaneously, e.g., on the same OFDM time-frequency resources, transmitting information to several UEs: the sequence S⁽¹⁾ is transmitted to UE(1), S⁽²⁾ is transmitted to UE(2), and so on. An antenna port may be a logical unit which may comprise one or more antenna elements. Before modulation and transmission, precoding W_{V}^{(j)} is applied to each sequence to mitigate multiplexing interference—the transmissions are spatially separated.

Each UE demodulates its received signal and combines receiver antenna signals to obtain an estimate Ŝ⁽ⁱ⁾ of the transmitted sequence. This estimate Ŝ⁽ⁱ⁾ for UE i may be expressed as (neglecting other interference and noise sources except the MU-MIMO interference)

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )}$$

The second term represents the spatial multiplexing interference, due to MU-MIMO transmission, seen by UE(i). A goal for a wireless communication network may be to construct a set of precoders {W_{V}^{(j)}} to meet a given target. One such target may be to make
the norm ∥H⁽ⁱ⁾W_{V}⁽ⁱ⁾∥ large (this norm represents the desired channel gain towards user i); and
the norm ∥H^{(j)}W_{V}⁽ⁱ⁾∥, j≠i small (this norm represents the interference of user i's transmission received by user j).

In other words, the precoder W_{V}⁽ⁱ⁾ shall correlate well with the channel H⁽ⁱ⁾ observed by UE(i) whereas it shall correlate poorly with the channels observed by other UEs.

To construct precoders WV⁽ⁱ⁾, i=1, . . . ,J that enable efficient MU-MIMO transmissions, the wireless communication network may need to obtain detailed information about the users downlink channels H(i), i=1, . . . ,J. The wireless communication network may for example need to obtain detailed information about all the users downlink channels H(i), i=1, . . . ,J.

In deployments where full channel reciprocity holds, detailed channel information may be obtained from uplink Sounding Reference Signals (SRS) that are transmitted periodically, or on demand, by active UEs. The wireless communication network may directly estimate the uplink channel from SRS and, therefore (by reciprocity), the downlink channel H⁽ⁱ⁾.

However, the wireless communication network cannot always accurately estimate the downlink channel from uplink reference signals. Consider the following examples:
In frequency division duplex (FDD) deployments, the uplink and downlink channels use different carriers and, therefore, the uplink channel may not provide enough information about the downlink channel to enable MU-MIMO precoding.
In TDD deployments, the wireless communication network may only be able to estimate part of the uplink channel using SRS because UEs typically have fewer TX branches than RX branches (in which case only certain columns of the precoding matrix may be estimated using SRS). This situation is known as partial channel knowledge.

If the wireless communication network cannot accurately estimate the full downlink channel from uplink transmissions, then active UEs need to report channel information to the wireless communication network over the uplink control or data channels. In LTE and NR, this feedback is achieved by the following signalling protocol:
The wireless communication network transmits Channel State Information reference signals (CSI-RS) over the downlink using N ports.
The UE estimates the downlink channel (or important features thereof such as eigenvectors of the channel or the Gram matrix of the channel, one or more eigenvectors that correspond to the largest eigenvalues of an estimated channel covariance matrix, one or more Discrete Fourier Transform (DFT) base vectors (described on the next page), or orthogonal vectors from any other suitable and defined vector space, that best correlates with an estimated channel matrix, or an estimated channel covariance matrix, the channel delay profile), for each of the N antenna ports from the transmitted CSI-RS.
The UE reports CSI (e.g., channel quality index (CQI), precoding matrix indicator (PMI), rank indicator (RI)) to the wireless communication network over an uplink control channel and/or over a data channel.
The wireless communication network uses the UE's feedback, e.g., the CSI reported from the UE, for downlink user scheduling and MIMO precoding.

In NR, both Type I and Type II reporting is configurable, where the CSI Type II reporting protocol has been specifically designed to enable MU-MIMO operations from uplink UE reports, such as the CSI reports.

The CSI Type II normal reporting mode is based on the specification of sets of Discrete Fourier Transform (DFT) basis functions in a precoder codebook. The UE selects and reports L DFT vectors from the codebook that best match its channel conditions (like the classical codebook precoding matrix indicator (PMI) from earlier 3GPP releases). The number of DFT vectors L is typically 2 or 4 and it is configurable by the wireless communication network. In addition, the UE reports how the L DFT vectors should be combined in terms of relative amplitude scaling and co-phasing.

Algorithms to select L, the L DFT vectors, and co-phasing coefficients are outside the specification scope—left to UE and network implementation. Or, put another way, the 3gpp Rel. 16 specification only defines signaling protocols to enable the above message exchanges.

In the following, “DFT beams” will be used interchangeably with DFT vectors. This slight shift of terminology is appropriate whenever the base station has a uniform planar array with antenna elements separated by half of the carrier wavelength.

The CSI type II normal reporting mode is illustrated in FIG. 3, and described in 3gpp TS 38.214 “Physical layer procedures for data (Release 16). The selection and reporting of the L DFT vectors bₙ and their relative amplitudes an is done in a wideband manner; that is, the same beams are used for both polarizations over the entire transmission frequency band. The selection and reporting of the DFT vector co-phasing coefficients are done in a subband manner; that is, DFT vector co-phasing parameters are determined for each of multiple subsets of contiguous subcarriers. The co-phasing parameters are quantized such that e^{jθn} is taken from either a Quadrature phase-shift keying (QPSK) or 8-Phase Shift Keying (8PSK) signal constellation.

With k denoting a sub-band index, the precoder W_{V}[k] reported by the UE to the network can be expressed as follows:

$${W}_{V} [ k ] = {\sum }_{n} {b}_{n} {a}_{n} {e}^{j {θ}_{n} [ k ]} .$$

The Type II CSI report can be used by the network to co-schedule multiple UEs on the same OFDM time-frequency resources. For example, the network can select UEs that have reported different sets of DFT vectors with weak correlations. The CSI Type II report enables the UE to report a precoder hypothesis that trades CSI resolution against uplink transmission overhead.

NR 3GPP Release 15 supports Type II CSI feedback using port selection mode, in addition to the above normal reporting mode. In this case,
The base station transmits a CSI-RS port in each one of the beam directions.
The UE does not use a codebook to select a DFT vector (a beam), instead the UE selects one or multiple antenna ports from the CSI-RS resource of multiple ports.

Type II CSI feedback using port selection gives the base station some flexibility to use non-standardized precoders that are transparent to the UE. For the port-selection codebook, the precoder reported by the UE can be described as follows

$${W}_{V} [ k ] = {\sum }_{n} {e}_{n} {a}_{n} {e}^{j {θ}_{n} [ k ]} .$$

Here, the vector e is a unit vector with only one non-zero element, which can be viewed as a selection vector that selects a port from the set of ports in the measured CSI-RS resource. The UE thus feeds back which ports it has selected, the amplitude factors and the co-phasing factors.

### Autoencoders for Artificial Intelligence (AI)-Enhanced CSI Reporting

Recently neural network (NN)-based autoencoders (AEs) have shown promising results for compressing downlink MIMO channel estimates for uplink feedback. That is, the AEs are used to compress downlink MIMO channel estimates. The compresses output of the AE is then used as uplink feedback. For example, prior art document Zhilin Lu, Xudong Zhang, Hongyi He, Jintao Wang, and Jian Song, “Binarized Aggregated Network with Quantization: Flexible Deep Learning Deployment for CSI Feedback in MassiveMIMO System”, arXiv, 2105.00354 v1, May, 2021 provides a recent summary of academic work.

An AE is a type of NN that may be used to compress and decompress data in an unsupervised manner.

Unsupervised learning is a type of machine learning in which the algorithm is not provided with any pre-assigned labels or scores for the training data. As a result, unsupervised learning algorithms may first self-discover any naturally occurring patterns in that training data set. Common examples include clustering, where the algorithm automatically groups its training examples into categories with similar features, and principal component analysis, where the algorithm finds ways to compress the training data set by identifying which features are most useful for discriminating between different training examples and discarding the rest. This contrasts with supervised learning in which the training data include pre-assigned category labels, often by a human, or from the output of non-learning classification algorithm.

FIG. 4a illustrates a fully connected, i.e., dense,) AE. The AE may be divided into two parts:
an encoder (used to compress the input data X), and
a decoder (used to recover important features of the input data).

The encoder and decoder are separated by a bottleneck layer that holds a compressed representation, Y in FIG. 4a, of the input data X. The variable Y is sometimes called the latent representation of the input X. More specifically,
The size of the bottleneck (latent representation) Y is smaller than the size of the input data X. The AE encoder thus compresses the input features X to Y.
The decoder part of the AE tries to invert the encoder's compression and reconstruct X with minimal error, according to some predefined loss function.

AEs may have different architectures. For example, AEs may be based on dense NNs (like FIG. 4a), multi-dimensional convolution NNs, recurrent NNs, transformer NNs or any combination thereof. However, all AEs architectures possess an encoder-bottleneck-decoder structure.

FIG. 4b illustrates how an AE may be used for AI-enhanced CSI reporting in NR during an inference phase, that is, during live network operation.
The UE estimates the downlink channel (or important features thereof) using configured downlink reference signal(s), e.g., CSI-RS. For example, the UE estimates the downlink channel as a 3D complex-valued tensor, with dimensions defined by the gNB's Tx-antenna ports, the UE's Rx antenna ports, and frequency units (the granularity of which is configurable, e.g., SubCarrier (SC) or subband). In FIG. 4b the 3D complex-valued tensor is illustrated as a rectangular hexahedron with lengths of the sides defined by the gNB's Tx-antenna ports, the UE's Rx antenna ports, and frequency (SC).
The UE uses a trained AE encoder to compress the estimated channel or important features thereof down to a binary codeword. The binary codework is reported to the network over an uplink control channel and/or data channel. In practice, this codeword will likely form one part of a channel state information (CSI) report that may also include rank, channel quality, and interference information. The CSI may be used for MU-MIMO precoding to shape an “energy pattern” of a wireless signal transmitted by the gNB.
The network uses a trained AE decoder to reconstruct the estimated channel or the important features thereof. The decompressed output of the AE decoder is used by the network in, for example, MIMO precoding, scheduling, and link adaption.

The architecture of an AE, e.g., structure, number of layers, nodes per layer, activation function etc., may need to be tailored for each particular use case, e.g., for CSI reporting. The tailoring may be achieved via a process called hyperparameter tuning. For example, properties of the data such as CSI-RS channel estimates, the channel size, uplink feedback rate, and hardware limitations of the encoder and decoder may all need to be considered when designing the AE's architecture.

After the AE's architecture is fixed, it needs to be trained on one or more datasets, meaning that trainable parameters of the AE are to be determined by processing these datasets. To achieve good performance during live operation in a network, the so-called inference phase, the training datasets need to be representative of the actual data the AE will encounter during live operation in a network.

The training process involves numerically tuning the AE's trainable parameters, e.g., the weights and biases of the underlying NN, to minimize a loss function on the training datasets. The loss function may be, for example, the Mean Squared Error (MSE) loss calculated as the average of the squared error between the UE's downlink channel estimate H and the network's reconstruction Ĥ, i.e., (H−Ĥ)². The purpose of the loss function is to meaningfully quantify the reconstruction error for the particular use case at hand.

The training process is typically based on some variant of the gradient descent algorithm, which, at its core, comprises three components: a feedforward step, a back propagation step, and a parameter optimization step. These steps will now be reviewed using a dense AE (e.g., a dense NN with a bottleneck layer, see FIG. 4a) as an example.

Feedforward: A batch of training data, such as a mini-batch, e.g., several downlink-channel estimates is pushed through the AE, from the input to the output. The loss function is used to compute the reconstruction loss for all training samples in the batch. The reconstruction loss may be an average reconstruction loss for all training samples in the batch.

The feedforward calculations of a dense AE with N layers (n=1,2, . . . , N) may be written as follows: The output vector α^{[n]} of layer n is computed from the output of the previous layer α^{[n-1]} using the equations

$${z}^{[ n ]} = {W}^{[ n ]} \cdot {a}^{[ n - 1 ]} + {b}^{[ n ]} ,$$

$${a}^{[ n ]} = g ( {z}^{[ n ]} ) .$$

In the above equation, W^{[n]} and b^{[n]} are the trainable weights and biases of layer n, respectively, and g is an activation function, for example, a rectified linear unit.

Back propagation (BP): The gradients, e.g., partial derivatives of the loss function, L, with respect to each trainable parameter in the AE, are computed. The back propagation algorithm sequentially works backwards from the AE output, layer-by-layer, back through the AE to the input. The back propagation algorithm is built around the chain rule for differentiation: When computing the gradients for layer n in the AE, it uses the gradients for layer n+1.

For a dense AE with N layers the back propagation calculations for layer n may be expressed with the following well-known equations

$$\frac{\partial L}{\partial {a}^{[ n ]}} = {[ {W}^{[ n + 1 ]} ]}^{T} \cdot \frac{\partial L}{\partial {z}^{[ n + 1 ]}} ,$$

$$\frac{\partial L}{\partial {z}^{[ n ]}} = \frac{\partial L}{\partial {a}^{[ n ]}} * {g}^{{[ n ]}^{′}} ( {z}^{[ n ]} ) ,$$

$$\frac{\partial L}{\partial {W}^{[ n ]}} = \frac{\partial L}{\partial {z}^{[ n ]}} \cdot {[ {a}^{[ n - 1 ]} ]}^{T} ,$$

$$\frac{\partial L}{\partial {b}^{[ n ]}} = \frac{\partial L}{\partial {z}^{[ n ]}} ,$$

where * here denotes the Hadamard multiplication of two vectors.

Parameter optimization: The gradients computed in the back propagation step are used to update the AE's trainable parameters. A simple approach is to use the gradient descent method with a learning rate parameter (α) that scales the gradients of the weights and biases, as illustrated by the following update equations

$${W}^{[ n ]} = {W}^{[ n ]} - α \cdot \frac{\partial L}{\partial {W}^{[ n ]}} ,$$

$${b}^{[ n ]} = {b}^{[ n ]} - α \cdot \frac{\partial L}{\partial {b}^{[ n ]}} .$$

A core idea here is to make small adjustments to each parameter with the aim of reducing the loss over the batch or mini batch. It is common to use special optimizers to update the AE's trainable parameters using gradient information. The following optimizers are widely used to reduce training time and improving overall performance: adaptive sub-gradient methods (AdaGrad), Root Mean Squared Propagation (RMSProp), and adaptive moment estimation (ADAM).

The above steps, i.e., feedforward, back propagation, parameter optimization, are repeated many times until an acceptable level of performance is achieved on the training dataset. An acceptable level of performance may refer to the AE achieving a pre-defined average reconstruction error over the training dataset. For example, normalized MSE of the reconstruction error over the training dataset is less than, say, 0.1. Alternatively, it may refer to the AE achieving a pre-defined user data throughput gain with respect to a baseline CSI reporting method. For example, a MIMO precoding method is selected, and user throughputs are separately estimated for the baseline and the AE CSI reporting methods.

The above steps use numerical methods, e.g., gradient descent, to optimize the AE's trainable parameters e.g., weights and biases. The training process, however, typically involves optimizing many other parameters, e.g., higher-level hyperparameters that define the model or the training process. Some example hyperparameters are as follows:
The architecture of the AE, e.g., dense, convolutional, transformer.
Architecture-specific parameters, e.g., the number of nodes per layer in a dense network, or the kernel sizes of a convolutional network.
The depth or size of the AE, e.g., number of layers.
The activation functions used at each node within the AE.
The mini-batch size, e.g., the number of channel samples fed into each iteration of the above training steps.
The learning rate for gradient descent and/or the optimizer.
The regularization method, e.g., weight regularization or dropout
   Additional validation datasets may be used to tune such hyperparameters.

The process of designing an AE, e.g., through hyperparameter tuning and model training, may be expensive—consuming significant time, compute, memory, and power resources.

AE-based CSI reporting is of interest for 3GPP Release 18 “AI/ML on PHY” study item, for example because of the following reasons:
AEs may include non-linear transformations, e.g., activation functions, that help improve compression performance and, therefore, help improve MU-MIMO performance for the same uplink overhead. For example, the normal Type II CSI codebooks in 3GPP Rel 16 are based on linear DFT transformations and Singular Value Decomposition (SVD), which cannot fully exploit redundancies in the channel for compression.
AEs may be trained to exploit long-term redundancies in the propagation environment and/or site, e.g., antenna configuration, for compression purposes. For example, a particular AE does not need to work well for all possible deployments. Improved compression performance is obtained by learning which channel inputs it needs to, and doesn't need to, reliably reconstruct the channels or a representation of the features of the channels needed by the base-station.
AEs may be trained to compensate for antenna array irregularities, including, for example, non-uniformly spaced antenna elements and non-half wavelength element spacing. The Type II CSI codebooks in Release 15 and 16, for example, use a two-dimensional DFT codebook designed for a regular planar array with perfect half wavelength element spacing.
AEs may be trained to be robust against, or updated to compensate for, e.g., via transfer learning and training, partially failing hardware as the massive MIMO product ages. For example, over time one or more of the multiple Tx and Rx radio chains in the massive MIMO antenna arrays at the base station may fail compromising the effectiveness of Type II CSI feedback. Transfer learning implies that parts of a previous neural network that has learned a different but often related task is transferred to the current network in order to speed up the learning process of the current network.

### SUMMARY

Typically, the AE training process is a highly iterative process that may be expensive—consuming significant time, compute, memory, and power resources. Therefore, it may be expected that AE architecture design and training will largely be performed offline, e.g., in a development environment, using appropriate compute infrastructure, training data, validation data, and test data. Data for training, validation, and testing may be collected from one or more of the following examples:
real measurements recorded in live networks,
synthetic radio channel data from, e.g., 3GPP channel models or ray tracing models and/or digital twins, and
mobile drive tests.

Validation data may be part of the development and tuning of the NN, whereas the test data may be applied to the final NN. For example, a “validation dataset” may be used to optimize AE hyperparameters like its architecture. For example, two different AE architectures may be trained on the same training dataset. Then the performance of the two trained AE architectures may be validated on the validation dataset. The architecture with the best performance on the validation dataset may be kept for the inference phase. In other words, validation may be performed on the same data set as the training, but on “unseen” data samples, e.g., taken from the same source. Test may be performed on a new data set, usually from another source and it tests the NN ability to generalize.

The training of the AE in FIG. 4b may have some similarities with split NNs, where an NN is split into two or more sections and where each section consists of one or several consecutive layers of the NN. These sections of the NN may be in different entities or nodes and each entity may perform both feedforward and back propagations. For example, in the case of splitting the NN into two sections, the feedforward outputs of a first section are pushed to a second section. Conversely, in the back propagation step, the gradients of the first layer of the second section are pushed into the last layer of the first section.

The split NN, a.k.a. split learning, was introduced primarily to address privacy issues with user data. In the training of an AE for CSI reporting, however, the privacy, i.e., proprietary, aspects of the sections, i.e., encoder and decoder, are of interest and training channel data may need to be shared to calculate reconstruction errors.

### Autoencoders for CSI Reporting—a Multi-Vendor Perspective

In AE-based CSI reporting, the AE encoder is in the UE and the AE decoder is in the wireless communications network, usually in the radio access network. The UE and the wireless communications network are typically represented by different vendors (which may also be the manufacturers), and, therefore, the AE solution needs to be viewed from a multi-vendor perspective with potential standardization, e.g., 3GPP standardization, impacts.

It is useful to recall how 3GPP 5G networks support uplink physical layer channel coding (error control coding).
The UE performs channel encoding and the network performs channel decoding. The channel encoders have been specified in 3GPP, which ensures that the UE's behaviour is understood by the network and may be tested.
The channel decoders, on the other hand, are left for implementation, they may for example be vendor proprietary.

If 3GPP specifies one or more AE-based CSI encoders for use in the UEs, then the corresponding AE decoders in the network may be left for implementation e.g., constructed in a proprietary manner by training the decoders against specified AE encoders. FIG. 4c illustrates a network vendor training of an AE decoder with a specified, e.g., untrainable, AE encoder. In short and as described above, a training method for the decoder may comprise comparing a loss function of the channel and the decoded channel, or some features thereof, computing the gradients, e.g., partial derivatives of the loss function, L, with respect to each trainable parameter in the AE, by back propagation, and updating the decoder weights and biases.

Some fundamental differences between AE-based CSI reporting and channel coding are as follows:
Channel coding has a long and well-developed academic literature that enabled 3GPP to pre-select a few candidate architectures, or types; namely, turbo codes, linear parity check codes, and polar codes. Channel codes may all be mathematically described as linear mappings that, in turn, may be written into a standard. Therefore, synthetic channel models may be sufficient to design, study, compare, and specify channel codes for 5G.
AEs for CSI feedback, on the other hand, have more architectural options and require many tuneable parameters, possibly hundreds of thousands. It is preferred that the AEs are trained, at least in part, on real field data that accurately represents live, in-network, conditions.

The standardization perspectives on AE-based CSI reporting may be summarized as follows:
AE encoder, or AE decoder, or both may be standardized in a first scenario:
   Training within 3GPP, e.g., NN architectures, weights and biases are specified,
   Training outside 3GPP, e.g., NN architectures are specified,
   Signalling for AE-based CSI reporting/configuration are specified,
AE encoder and AE decoder may be implementation specific, e.g., vendor proprietary, in a second scenario:
   Interfaces to the AE encoder and AE decoder are specified,
   Signalling for AE-based CSI reporting/configuration are specified.

AE-based CSI reporting has at least the following implementation/standardization challenges and issues to solve:
The AE encoder and the AE decoder may be complicated NNs with thousands of tuneable parameters, e.g., weights and biases, that potentially need to be open and shared, e.g., through signalling, between the network vendors and the UE vendors.
The UE's compute resources or power resources or both are limited so the AE encoder will likely need to be known in advance to the UE such that the UE implementation may be optimized for its task.
   The AE encoder's architecture will most likely need to match chipset vendors hardware, and the model, with weights and biases possibly fixed, will need to be compiled with appropriate optimizations. The process of compiling the AE encoder may be costly in time, compute, power, and memory resources. Moreover, the compilation process requires specialized software tool chains to be installed and maintained on each UE.
The AE may depend on the UE's, and/or network's, antenna layout and RF chains, meaning that many different trained AEs, corresponding to different NNs, may be required to support all types of base station and UE designs.
The AE design is data driven meaning that the AE performance will depend on the training data. A specified AE, either encoder or decoder or both, developed using synthetic training data, e.g., specified 3GPP channel models, may not generalize well to radio channels observed in real deployments.
   To reduce the risk of overfitting to synthetic data, one may need to refine the 3GPP channel models and/or share a vast number of field data for training purposes.
   Here, overfitting means that the AE generalizes poorly to real data, or data observed in field, e.g., the AE achieves good performance on the training dataset, but when used in the real work, e.g. on the test set, it has poor performance.
In specifying either an AE encoder or an AE decoder, there may be a need for 3GPP to agree on at least one reference AE decoder or encoder). That is, when specifying the AE encoder, there may be a need for 3GPP to agree on at least one reference AE decoder. Similarly, when specifying the AE decoder, there may be a need for 3GPP to agree on at least one reference AE encoder. These reference models will be needed to provide a minimal framework for discussions and specification work, but they may leave room for vendor specific implementations of the AE decoder or encoder.

Given the above challenges and issues with multi-vendor AE-based CSI reporting, there is a need for a standardized procedure that enables joint training of the AE-encoder, e.g., implemented by a UE or chipset vendor and the AE-decoder, e.g., implemented by a network vendor. The joint training procedure may protect proprietary implementations of the AE encoder and decoder; that is, it may not expose details of the encoder and/or decoder trained weights and loss function to the other party.

A first reference method to train a network's AE decoders for receiving CSI reports in live networks and enabling proprietary AE encoders for CSI in the UE and also proprietary AE decoders in the network will be outlined in short below.

In the first reference method the network constructs a training dataset for each UE AE encoder by logging the UE's CSI report received over the air interface, e.g., the AE encoder output, together with the network's SRS-based estimate of the UL channel. The resulting dataset may then be used to train the network's AE decoder without having to know the UE's AE encoder since the network knows, from the dataset, both the input and the output of the encoder. This solution assumes that the CSI-RS based estimated downlink channel measured by the UE, i.e., the input to the AE encoder, may be well approximated by the uplink channel measured by the network using the SRSs.

Instead of supporting “fully proprietary AE encoders” in the UE, another second reference solution to the above problem may be to split the AE encoder into two parts—a UE proprietary part and a standardized part. More specifically, the UE vendor may implement a proprietary mapping, e.g., a NN mapping, from the channel measurements on its receive antenna ports e.g. the CSI-RS-based channel estimate, to a standardized channel feature space. The standardized channel feature space may be a latent representation of the channel designed using, for example, DFT basis vectors.

The estimated channel features may then be input to a reference AE encoder that is known to all parties, e.g., UE and network vendors. Since the AE encoder is known to all parties, network vendors may design and implement AE decoders using proprietary datasets and methods.

The first reference solution above enables proprietary AE encoders in the UE and proprietary AE decoders in the network, but it may have the following limitations:

The network's SRS-based estimate of the uplink channel is used as an approximate copy of the UE's CSI-RS-based estimate of the downlink channel, i.e., the input to the AE.
If there is only partial channel reciprocity, e.g., in an FDD deployment, then the SRS-based estimate will only include the channel's large-scale fading state, which may not be sufficient to enable MU-MIMO transmissions. The AE decoder may not learn to decode the small-scale fading state, which may impact MU-MIMO performance.
The UE may have fewer TX chains than RX chains, and, therefore, even in TDD, only partial channel reciprocity may be obtained, as the SRS-based channel estimate may only include some columns of the channel matrix.
The UE may have more downlink carriers than uplink carriers. Hence, some DL carriers do not have a corresponding uplink carrier and SRS cannot be transmitted.
Commonly, the UEs are unable to maintain the same transmit power on all SRS antenna ports. The transmit power may vary several decibel over the SRS antenna ports, and the network may not know whether a faded channel measured on an SRS antenna port comes from the true channel or if it comes from a lower transmit power, compared to other SRS antenna ports. Hence, the channel measured on SRS does not perfectly reflect the downlink channel.
The AE encoder is UE implementation specific and, therefore, the network may have to deploy and maintain many different AE decoders—potentially one for each UE encoder. Supporting many UE AE encoder models may result in excessive training and model management costs.

A limitation of the approach outlined in the second reference method may be that the decoder may only reconstruct standardized channel features. That is, any channel state information lost in the UE's proprietary mapping from its CSI-RS measurements to the standardized channel feature space may not be recovered by the BS.

Thus, there exist problems related to how to introduce specification support for AI-based CSI reporting solutions in multi-vendor networks, where both UE and base station can be provided by many different manufacturers?

An object of embodiments herein may be to obviate some of the problems related to support for AE in wireless communication networks.

According to an aspect, the object is achieved by a method, performed by a first communications node, such as a UE, for providing channel state information, CSI, in a wireless communications network, to a second communications node, such as radio access node. The first communications node has access to one or more trained NN-based AE-encoder models for encoding the CSI and the second communications node has access to one or more trained NN-based AE-decoder models for decoding the CSI provided by the first communications node.

The method comprises:
receiving, from the second communications node, an indication of an NN-based AE-decoder model out of the one or more trained NN-based AE-decoder models;
selecting a trained NN-based AE-encoder model out of the one or more trained NN-based AE-encoder models to use for the NN-based AE-encoder based on the received indication of the NN-based AE-decoder model such that the selected trained NN-based AE-encoder model is compatible with the indicated NN-based AE-decoder model; and
transmitting, e.g., over a radio-based air interface and using a standardised radio transmission protocol, the CSI to the second communications node based on output from the selected trained NN-based AE-encoder model.

According to a second aspect, the object is achieved by a first communications node. The first communications node is configured to perform the method according to the first aspect above.

According to a third aspect, the object is achieved by a method, performed by a second communications node, such as radio access node, for assisting a first communications node in providing channel state information, CSI, to the second communications node in a wireless communications network. The first communications node has access to one or more trained NN-based AE-encoder models for encoding the CSI and the second communications node has access to one or more trained NN-based AE-decoder models for decoding the CSI provided by the first communications node.

The method comprises:
transmitting an indication of an NN-based AE-decoder model out of the one or more trained NN-based AE-decoder models;
receiving, e.g., over a radio-based air interface and using a standardised radio transmission protocol, the CSI from the first communications node based on output from a trained NN-based AE-encoder model selected out of the one or more trained NN-based AE-encoder models based on the transmitted indication of the NN-based AE-decoder model.

According to a fourth aspect, the object is achieved by a second communications node. The second communications node is configured to perform the method according to the third aspect above.

According to a further aspect, the object is achieved by a computer program comprising instructions, which when executed by a processor, such as a processor of a communications node, causes the processor to perform actions according to any of the aspects above.

According to a further aspect, the object is achieved by a carrier comprising the computer program of the aspect above, wherein the carrier is one of an electronic signal, an optical signal, an electromagnetic signal, a magnetic signal, an electric signal, a radio signal, a microwave signal, or a computer-readable storage medium.

The above aspects provide a possibility to enable Machine Learning (ML)-based CSI feedback using proprietary encoders. In some embodiments herein, ML-based CSI feedback is also termed AE CSI reporting. Embodiments disclosed herein enable ML-based CSI feedback using proprietary encoders. Thus, the UE's AE encoder does not need to be standardized, nor does its architecture or parameters or both need to be revealed to the wireless communications network.

A number of 3GPP AE decoders may be standardized by an appropriate standardization body e.g., 3GPP. For example, a set of 3GPP AE decoder architectures are standardized e.g., dense NNs, convolutional NNs, or transformer NNs, and trained instances of these decoders are shared by wireless communication network vendors via, for example, one or more ML model repositories.

The vendor of the wireless communications network selects which 3GPP AE decoders and loss functions it will support. For example, the vendor of the wireless communications network may limit the number of supported decoders to reduce product complexity.

Vendors of wireless communications networks may compete on the following:
The specific implementation of the 3GPP AE decoders and hardware on which they run e.g., on complexity, power usage, and cost.
The configuration of the AE-based CSI report e.g., which AE-decoder to use in a given deployment.
Efficient utilization of the AE-based CSI report e.g., MU-MIMO precoding and scheduling.
Providing UE vendors with good data and relevant benchmarks to train the AE encoders.

The proposed solution may perform better than the reference solutions proposed above, since it allows the vendor of the UE to fully access the reference decoders including architectures, weights, biases, and loss functions.

### BRIEF DESCRIPTION OF THE DRAWINGS

In the figures, features that appear in some embodiments are indicated by dashed lines.

The various aspects of embodiments disclosed herein, including particular features and advantages thereof, will be readily understood from the following detailed description and the accompanying drawings, in which:

FIG. 1 illustrates a simplified wireless communication system,

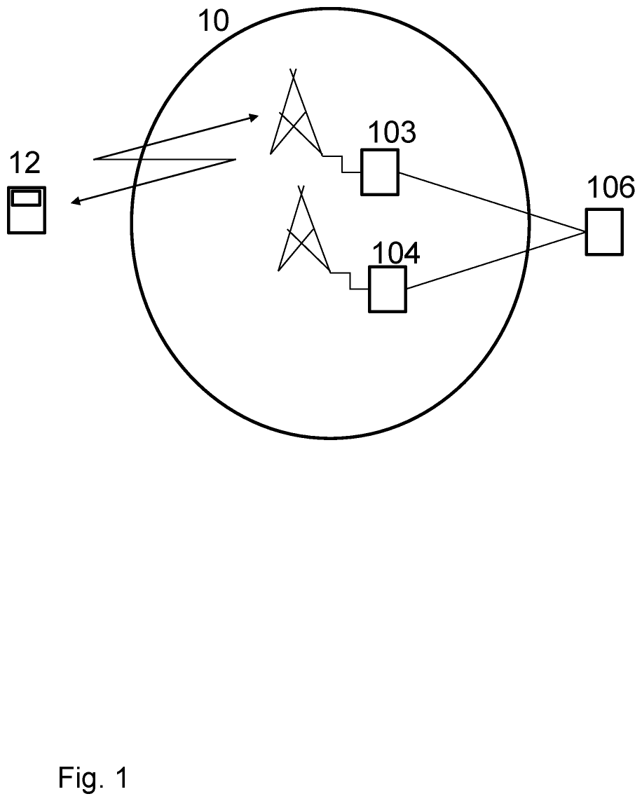

FIG. 2 illustrates an example transmission and reception chain for MU-MIMO operations,

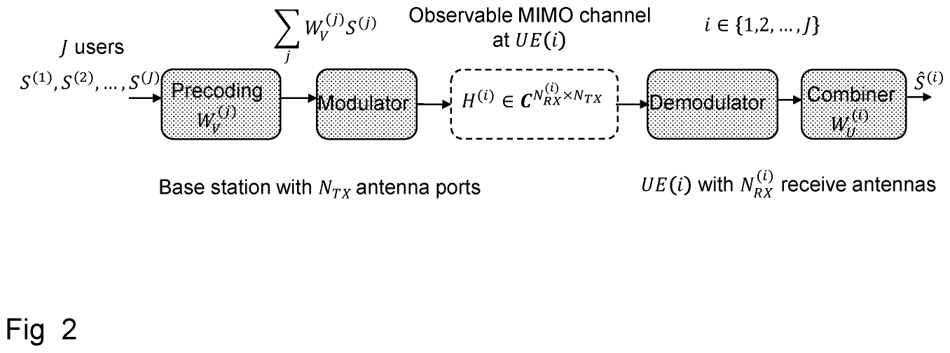

FIG. 3 is a block diagram schematically illustrating CSI type II normal reporting mode,

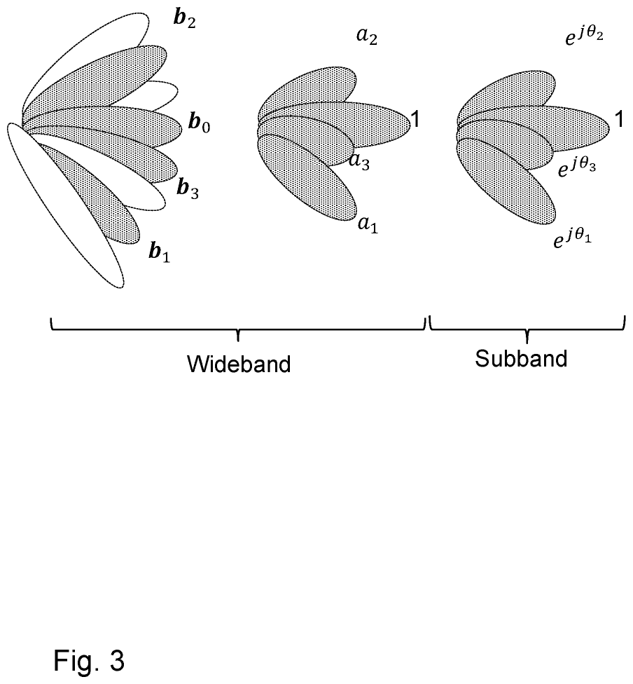

FIG. 4a schematically illustrates a fully connected (i.e., dense) AE,

FIG. 4b is a block diagram schematically illustrating how an AE may be used for AI-enhanced CSI reporting in NR during an inference phase

FIG. 4c is a block diagram schematically illustrating a network vendor training of an AE decoder with a specified (e.g., untrainable) AE encoder.

FIG. 5a illustrates a wireless communication system according to embodiments herein,

FIG. 5b is a block diagram schematically illustrating details of a first communications node 521 and a second communications node 511 according to embodiments herein,

FIG. 6 is a flow chart describing a method according to embodiments herein,

FIG. 7 is a flow chart describing a method according to embodiments herein,

FIG. 8 is a block diagram schematically illustrating a first communications node according to embodiments herein,

FIG. 9 is a block diagram schematically illustrating a second communications node according to embodiments herein,

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12 to 15 are flowcharts illustrating methods implemented in a communication system including a host computer, a base station and a user equipment.

### DETAILED DESCRIPTION

As mentioned above, training of AE for CSI reporting in wireless communication networks may be improved in several ways. An object of embodiments herein is therefore to improve training of AE for CSI reporting in wireless communication networks.

Embodiments disclosed herein assume a set of standardised reference, e.g. 3GPP-defined, AE decoders. The AE decoders may be defined by e.g., architectures, weights, biases, and loss functions for the decoding of the CSI message in a network node, e.g. the gNB. The UE AE encoders may then be fully or partially left for UE side implementation.

Embodiments disclosed herein are opposite to normal specification procedures in 3GPP, where the encoder in the UE is specified and the decoder in the network is left to implementation e.g., Low-density parity-check, LDPC, codes or Polar codes.

The AE decoders used on the network side may be shared offline or online, via a model repository or be standardized.

UE vendors may design AE encoders for the reference AE decoders using proprietary methods and datasets.

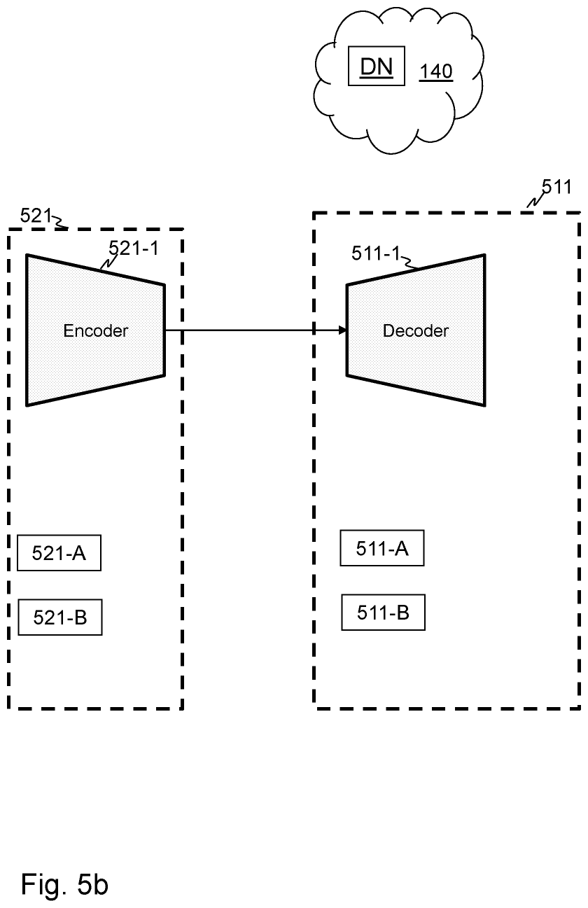

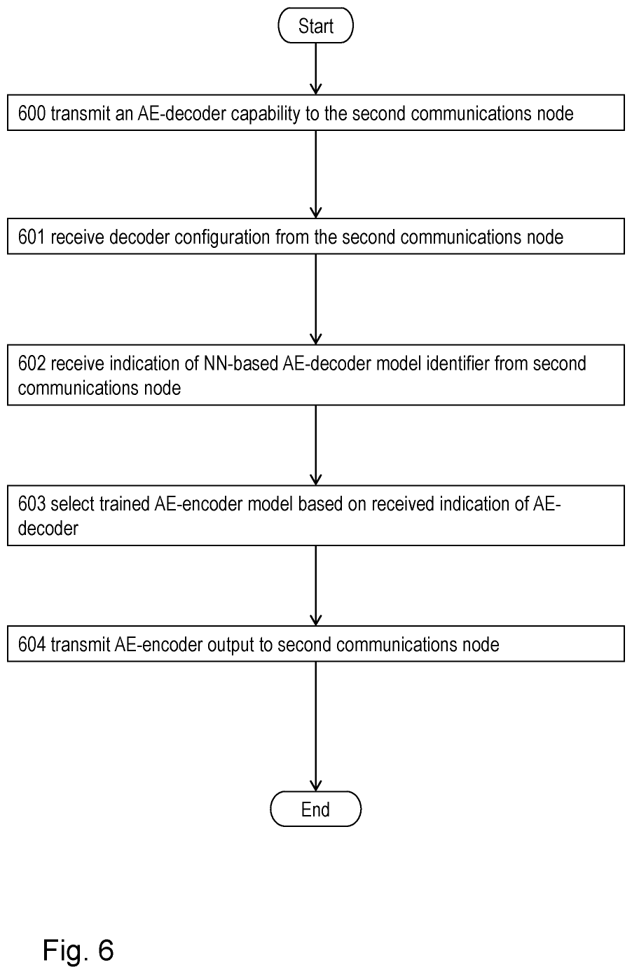

Embodiments herein relate to wireless communication networks in general. FIG. 5a is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

Access nodes operate in the wireless communications network 100 such as a radio access node 111. The radio access node 111 provides radio coverage over a geographical area, a service area referred to as a cell 115, which may also be referred to as a beam or a beam group of a first radio access technology (RAT), such as 5G, LTE, Wi-Fi or similar. The radio access node 111 may be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area depending e.g. on the radio access technology and terminology used. The respective radio access node 111 may be referred to as a serving radio access node and communicates with a UE with Downlink (DL) transmissions to the UE and Uplink (UL) transmissions from the UE.

A number of wireless communications devices operate in the wireless communication network 100, such as a UE 121.

The UE 121 may be a mobile station, a non-access point (non-AP) STA, a STA, a user equipment and/or a wireless terminals, that communicate via one or more Access Networks (AN), e.g. RAN, e.g. via the radio access node 111 to one or more core networks (CN) e.g. comprising a CN node 130, for example comprising an Access Management Function (AMF). It should be understood by the skilled in the art that “UE” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

FIG. 5b illustrates details of a first communications node 521, such as the UE 121, and a second communications node 511, such as the radio access node 111. The communications nodes 521, 511 may also be referred to as networks nodes as they operate in the wireless communications network 100. The first communications node 521 may comprise an AE-encoder 521-1. The first communications node 521 has access to one or more trained NN-based AE-encoder models 521-A, 521-B for encoding the CSI. The second communications node 511 may comprise an AE-decoder 511-1. The second communications node 511 has access to one or more trained NN-based AE-decoder models 511-A, 511-B for decoding the CSI provided by the first communications node 521.

In FIG. 5b the first communications node 521 and the second communications node 511 have been illustrated as single units. However, as an alternative, each communications node 521, 511 may be implemented as a Distributed Node (DN) and functionality, e.g. comprised in a cloud 140 as shown in FIG. 5b. Thus, DNs and a distributed functionality may be used for performing or partly performing the methods. There may be a respective cloud for each communications node.

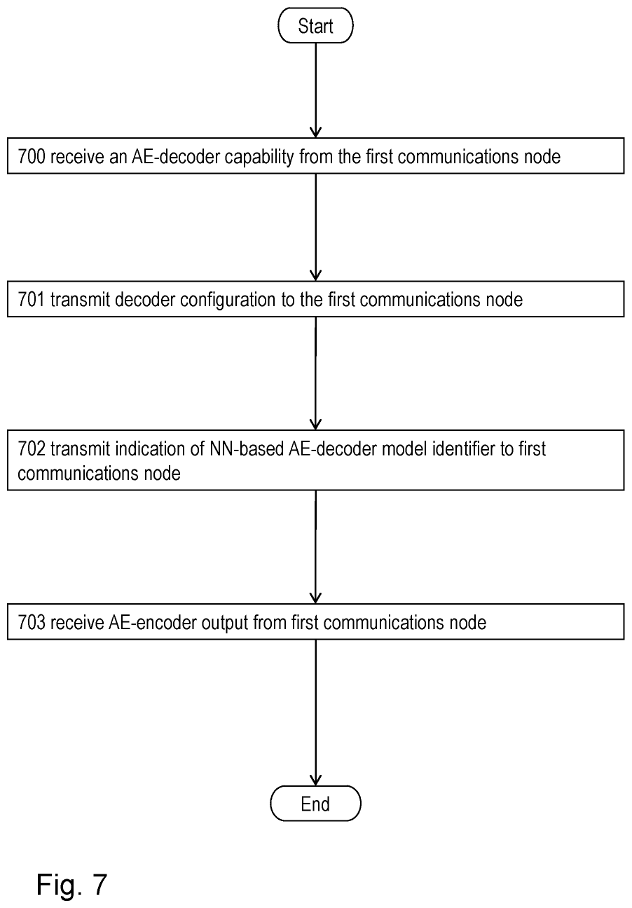

Appropriate methods to handle AE-based CSI reporting are provided below. Exemplifying methods according to embodiments herein will now be described with reference to a flow chart in FIG. 6 and with continued reference to FIGS. 5a and 5b. The flow chart illustrates a method, performed by the first communications node 521, such as the UE 121, for providing CSI in the wireless communications network 100, to the second communications node 511, such as the radio access node 111.

As a first optional action 600 of FIG. 6 the first communications node 521 may transmit an AE-decoder capability to the second communications node 511, for example, using Radio Resource Control (RRC) signalling on joining the communications network 100. The first communications node 521 has access to one or more trained NN-based AE-encoder models 521-A, 521-B for encoding the CSI and the second communications node 511 has access to one or more trained NN-based AE-decoder models 511-A, 511-B for decoding the CSI provided by the first communications node 521.

In a next optional action 601 of FIG. 6, the first communications node 521 may receive, from the second communications node 511, a decoder configuration comprising an indication to use an AE CSI reporting mode for which the first communications node 521 is configured to use the trained NN-based AE-encoder model 521-A compatible with the indicated NN-based AE-decoder model 511-A.

In action 602 of FIG. 6, the first communications node 521 receives, from the second communications node 511, an indication of an NN-based AE-decoder model 511-A out of the one or more trained NN-based AE-decoder models 511-A, 511-B.

The indicated NN-based AE-decoder model 511-A may be known to the first communications node 521.

The indication of the NN-based AE-decoder model 511-A may be received from the second communications node 511 with a CSI reporting configuration.

The CSI reporting configuration may indicate one or more CSI feedback parameters associated with NN-based AE.

The CSI configuration may indicate whether the CSI report shall use periodic PUCCH or aperiodic PUSCH to convey the CSI report to the second communications node 511.

The AE CSI reporting mode may be configured with aperiodic CSI reporting.

The indication of the NN-based CSI decoder model may be determined by at least a CSI resource configuration used for channel measurement.

For example, CSI resource configuration may comprise one or more of: a configuration of a number of CSI-RS ports (e.g. 16 or 32), of the second communications node 111, a CSI-RS port layout (e.g., parameters N1, N2, O1, O2), and an indication of whether the CSI report shall be periodic or aperiodic. For the CSI-RS port layout parameters N1, N2, O1, O2, N1 may be determined by the number of antennas in horizontal direction, N2 may be determined by the number of antennas in horizontal direction vertical direction, O1 may determine a sweeping step in horizontal direction and O2 may determine a sweeping step in vertical direction.

In action 603 of FIG. 6, the first communications node 521 selects a trained NN-based AE-encoder model 521-A out of the one or more trained NN-based AE-encoder models 511-A, 521-B to use for the NN-based AE-encoder based on the received indication of the NN-based AE-decoder model 511-A such that the selected trained NN-based AE-encoder model 521-A is compatible with the indicated NN-based AE-decoder model 511-A.

The trained NN-based AE-encoder models 521-A, 521-B may be either software e.g., running in a docker container, or a specialized hardware that only runs those trained NNs.

In action 604 of FIG. 6, the first communications node 521 transmits, e.g., over the radio-based air interface 123-UL and using a standardised radio transmission protocol, the CSI to the second communications node 511 based on output from the selected trained NN-based AE-encoder model 521-A.

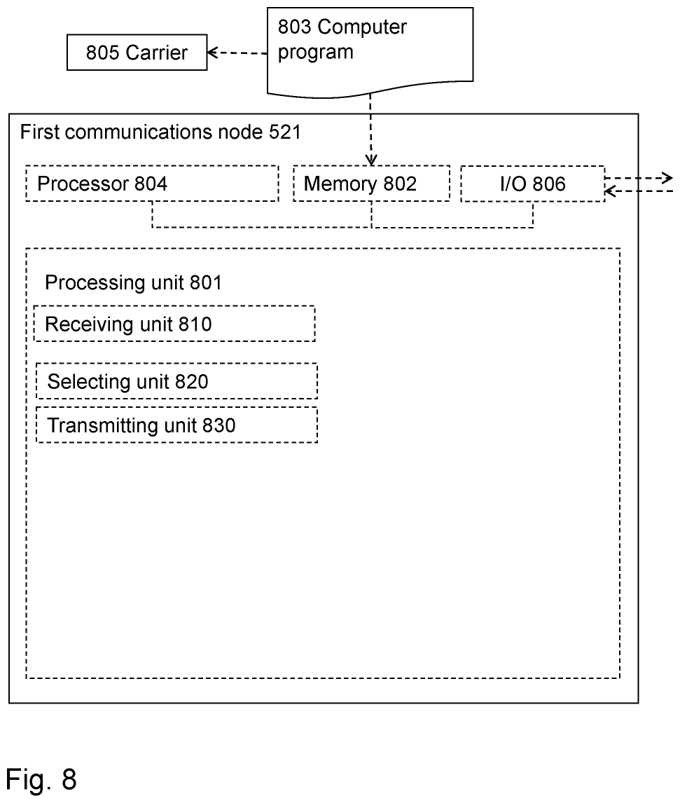

Exemplifying methods according to embodiments herein will now be described with reference to a flow chart in FIG. 7 and with continued reference to FIGS. 5a and 5b. The flow chart illustrates a method, performed by the second communications node 511, such as the radio access node 111, for assisting the first communications node 521 in providing CSI to the second communications node 511 in the wireless communications network 100.

As mentioned above, the first communications node 521 has access to one or more trained NN-based AE-encoder models 521-A, 521-B for encoding the CSI and the second communications node 511 has access to one or more trained NN-based AE-decoder models 511-A, 511-B for decoding the CSI provided by the first communications node 521.

As a first optional action 700 of FIG. 7 the second communications node 511 may receive the AE-decoder capability from the first communications node 521, for example, using RRC signalling when the first communications node 511 joins the wireless communications network 100

In a further optional action 701 the second communications node 511 may transmit, to the first communications node 521, a decoder configuration comprising an indication to use an AE CSI reporting mode for which the first communications node 521 is configured to use the trained NN-based AE-encoder model 521-A compatible with the indicated NN-based AE-decoder model 511-A.

In a further action 702 the second communications node 511 transmits an indication of an NN-based AE-decoder model 511-A out of the one or more trained NN-based AE-decoder models 511-A, 511-B. The second communications node 511 may transmit the indication of the NN-based AE-decoder model 511-A to the first communications node 521.

In a further action 703 the second communications node 511 receives, e.g., over the radio-based air interface 123-UL and using a standardised radio transmission protocol, the CSI from the first communications node 511 based on output from the trained NN-based AE-encoder model 521-A selected out of the one or more trained NN-based AE-encoder models 521-A, 521-B based on the transmitted indication of the NN-based AE-decoder model 511-A.

### Detailed Embodiments

As mentioned above embodiments herein disclose methods for providing CSI over a radio-based air interface, from the first communications node 521 to the second communications node 511. In order to perform such methods the following may be defined:
An NN-based CSI encoder in the first communications node 521, of which NN implementation is proprietary for the manufacturers of the first communications node 521, partly or fully, and not known nor accessible to the manufacturers of the NN of the second communications node 511. Thus the NN-based CSI encoder in the first communications node 521 is at least partly not known nor accessible to the second communications node 511.
A radio transmission protocol for conveying the output of the encoder over the radio interface, to the input of the decoder, comprising one or more of information quantization, error correction coding, error detection coding, modulation, retransmission protocols.
An NN-based CSI decoder in the second communications node 511, of which NN implementation is shared, partly or fully, to the manufacturers of the first communications node 521.
Signalling of a NN decoder model identifier, e.g., a decoder index, from the second communications node 511 to the first communications node 521 to be used by the first communications node 521 to determine the encoder model to use. For example, the first communications node 521 may determine the encoder model to be used based on the NN decoder model identifier by selecting an encoder model which is compatible with the identified decoder model. In some embodiments the first communications node 521 may select a most optimal compatible encoder model out of a set of compatible encoder models, e.g., based on loss values or required computing resources.

Further, the proposed solution may comprise one or more of the following embodiments
A set of standardized AE decoders, e.g., defined by architectures, weights, biases, and loss functions, may be shared in, for example, 3GPP via specifications and/or an AI model repository. For example, the 3GPP AE decoders may be shared via a dedicated AI/ML-model repository using an agreed format which is captured in the 3GPP specifications. The dedicated AI/ML-model repository may for example be provided from the DN of the cloud 140. The 3GPP specifications may also describe an architecture of the NN and loss functions, although the weights and biases may be given by such repository. Each such decoder model may be indexed with a decoder index or identifier. The decoder model identifier may be signalled from the radio access node 111 to the wireless communications devices, such as the UE 121, when configuring a CSI report. Thus, the decoder index (or identifier) may be signalled from the radio access node 111 to the UE 121 using higher layer signalling such as RRC signalling.
   A decoder index may also be implicitly signalled, for example, a certain configuration of the number of CSI-RS ports (e.g. 16 or 32) and the port layout (N1, N2, O1, O2), (see 3gpp TS 38.214, e.g. v15.8.0 for codebook configuration parameters), may implicitly imply that a certain decoder index is conveyed from the radio access node 111 to the UE 121 to be used by the UE 121 to select a certain encoder model among several encoder models.
   A decoder index may be implicitly signalled by the type of configured CSI report such that a configured periodic CSI reporting points to one decoder index and a configured aperiodic CSI reporting points to another decoder index.
   A decoder index may be implicitly signalled by a CSI-RS configuration together with the type of configured CSI reporting such that a configured periodic CSI reporting points to a set of decoder indices wherein the CSI-RS configuration points to an index within this set.
The set of 3GPP AE decoders may be jointly designed in 3GPP and/or designed proprietarily by individual vendors of network equipment and wireless communications devices and operators.
   If an AE decoder is jointly designed in 3GPP, the signalling of a decoder index from the radio access node 111 to the UE 121 may point to the jointly designed AE decoder.
   If the AE decoder is proprietarily designed by different vendors of radio access nodes, then there may be a signalling of a decoder identifier which comprises a vendor identifier and a decoder index for that vendor. Alternatively, an index to a global database of proprietary decoder indices may be made.
vendors of wireless communications devices, such as the UE 121, may use proprietary technologies and data to design AE encoders for selected 3GPP AE decoders. The trained AE encoders do not need to be shared in 3GPP. The vendors of wireless communications devices may use proprietary methods to implement these AE encoders into their products.
   Even though the AE encoder is proprietary, some parts may still be specified in 3GPP. For example, 3GPP may specify details of the AE encoder output layer(s) to handle quantization and mapping to the Uplink Control Information (UCI) payload.
vendors of network equipment may use proprietary technologies and data to implement selected 3GPP AE decoders in base station products, e.g., gNB products. For example, the vendor of network equipment may choose to optimize (e.g., quantize or compress) a 3GPP AE decoder to reduce power consumption, latency, or compute requirements specifically for its product hardware.
On joining the wireless communications network 100, the UE 121 may signal an AE decoder capability to the radio access node 111, for example, using RRC signalling. For example, the UE 121 signals a list of supported reference AE decoders e.g., using said decoder indices/identifiers. Based on the received UE capability information, the wireless communications network, e.g., the radio access node 111, configures the UE 121 with one or more of the following reporting modes:
   AI/ML-enhanced CSI reporting mode: The wireless communications network 100 configures the UE 121 to use a 3GPP AE decoder for a first CSI report configuration.
   Legacy CSI reporting mode: The wireless communications network configures the UE 121 to use a legacy CSI reporting mode (e.g., Rel 16 Type I or II) for a second CSI report configuration.

The wireless communications devices, such as the UE 121, may thus be configured with one or multiple AI/ML-enhanced CSI reporting modes and one or multiple legacy reporting modes in parallel, e.g., one mode per configured CSI report configuration.

In a typical configuration, a legacy reporting mode is configured for periodic reporting while an AI/ML enhanced CSI reporting mode is configured for aperiodic CSI reporting

In a further detailed embodiment, the wireless communications network 100 indicates a 3GPP decoder to the wireless communications devices, such as the UE 121, for example, as part of the CSI report configuration. The report configuration is associated with a CSI-ResourceConfig, which contains the CSI-RS resource(s) that the UE 121 shall use for channel measurement and possibly also interference measurements, used to compute the CSI report information.

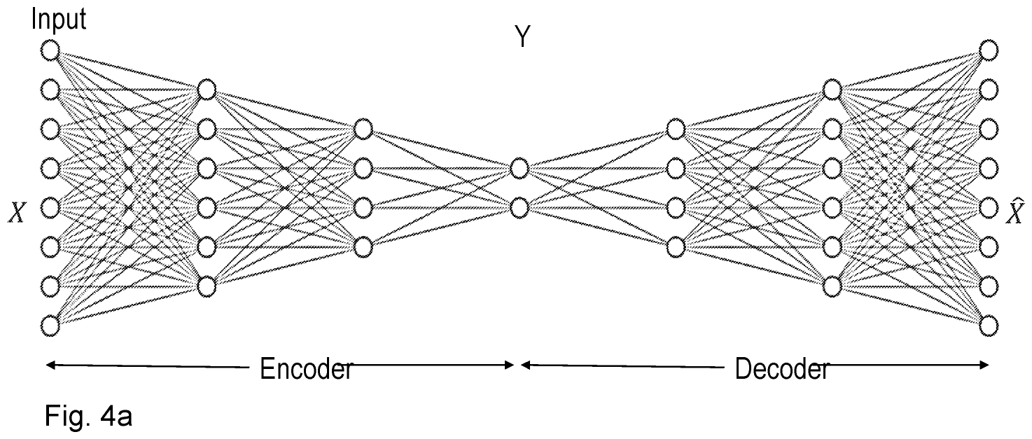

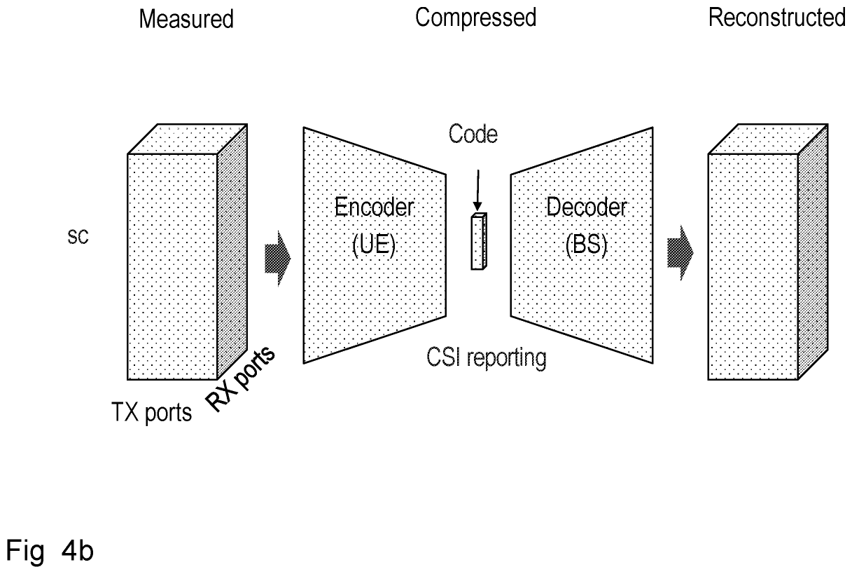

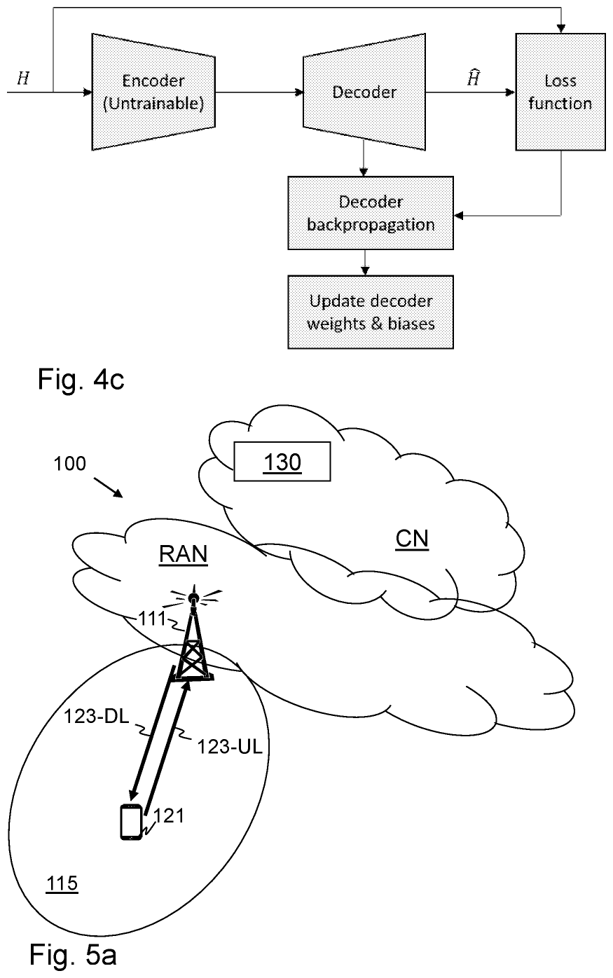

The configuration indicated from the network to the UE 121 may comprise one or more of the following parameter(s):
The decoder configuration for the configured report comprising one or more of:
   The CSI feedback payload size over the air interface e.g., UCI bits. For example, the available number of bits in the “Code” in FIG. 4b. This may be used to control the accuracy similar to Type I like report or Type ∥ like rich report.
   The used encoder output and quantization and/or ordering of bits in “Code” that maps to UCI payload bits.
   Whether the associated configured CSI-RS resource(s) are assumed to be beamformed or not. E.g., if beamformed, it resembles Type ∥ port selection.
   If beamformed, whether the associated configured CSI-RS resource(s) are assumed to be time compensated or not. E.g., if beamformed and time compensated, it resembles Rel.17 Type II CSI feedback where the channel appears to be more frequency flat at the UE 121.
   Whether the associated configured CSI-RS resource(s) are assumed to be a single Transmit/Receive Point (TRP) or multi-TRP transmission. E.g., single Transmission Configuration Indicator (TCI) state or multiple TCI states.
   The configured spatial richness/rank of the report, e.g., if the decoder is specified with the intention that the UE 121 shall report the full spatial channel or a subset of the spatial channel. This may be equivalent to rank restriction in the legacy codebooks.
   The configured frequency domain accuracy of the report, e.g., if the decoder is specified with the intention that the UE 121 shall report a wideband (e.g, frequency averaged) channel or per detailed subband channel information.
   The time domain behaviour of the report, e.g., if the decoder is specified with the intention that the UE 121 shall report an instantaneous channel snapshot (e.g., one CSI-RS measurement) or time domain averaged (e.g., using multiple CSI-RS receptions).
   Whether the decoder is specified with the intention that the report should be causal or predictive and if predictive how far (e.g. how many number of slots) into the future. E.g., whether the UE 121 is expected to perform prediction or not, if the reference slot is before the report or in the future, after the report.
The report time-domain behavior, whether the report is using periodic PUCCH or aperiodic PUSCH to convey the report to the network 100.

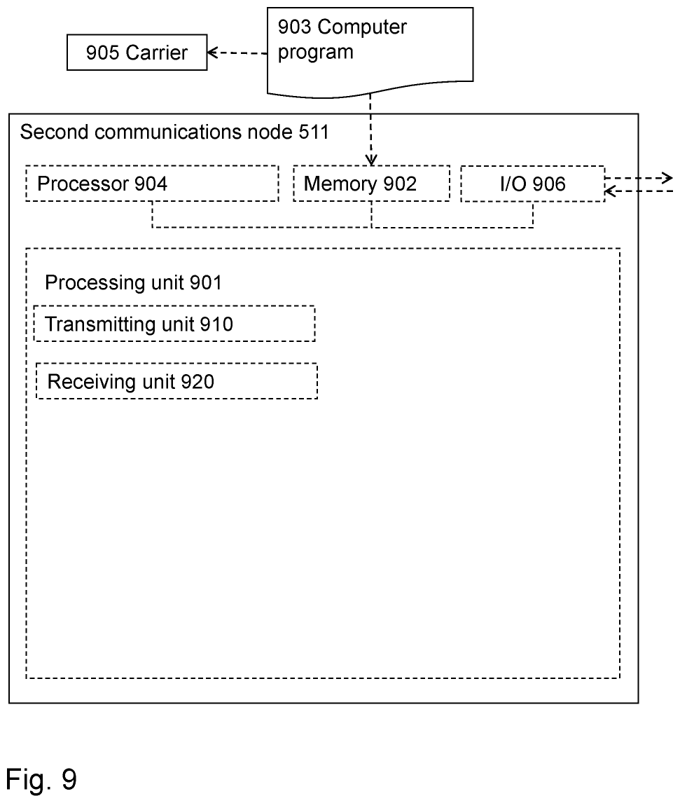

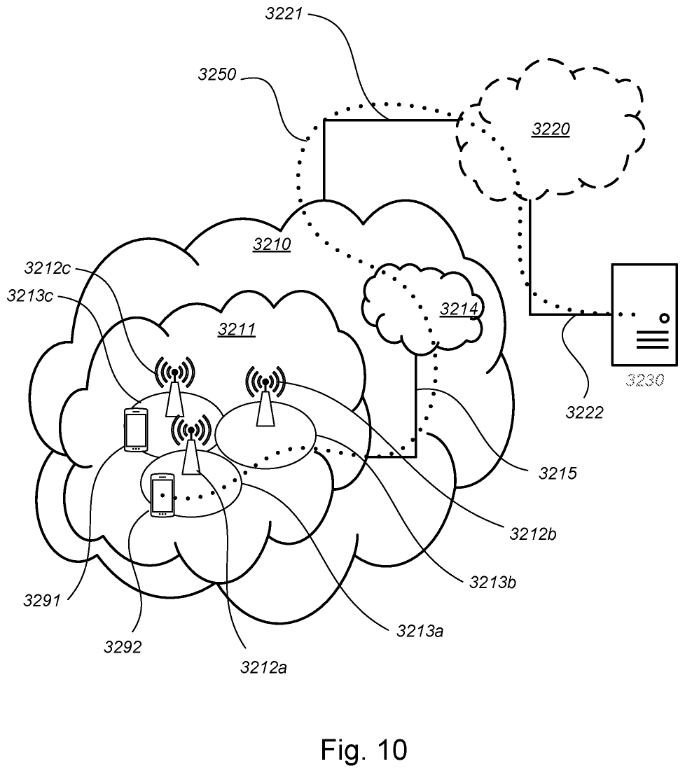

FIG. 8 shows an example of the first communications node 521 and FIG. 9 shows an example of the second communications node 511. The first communications node 521 may be configured to perform the method actions of FIG. 6 above. The second communications node 511 may be configured to perform the method actions of FIG. 7 above.

Specifically, the first communications node 121 is configured to access the one or more trained NN-based AE-encoder models 521-A, 521-B for encoding the CSI and the second communications node 111 is configured to access the one or more trained NN-based AE-decoder models 511-A, 111-B for decoding the CSI provided by the first communications node 121.

The first communications node 521 and the second communications node 511 may each comprise a respective input and output interface, IF, 806, 906 configured to communicate with each other, see FIGS. 8-9. The input and output interface may comprise a wireless receiver (not shown) and a wireless transmitter (not shown).

The first communications node 521 and the second communications node 511 may each comprise a respective processing unit 801, 901 for performing the above method actions. The respective processing unit 801, 901 may comprise further sub-units which will be described below.

The first communications node 521 and the second communications node 511 may further comprise a respective a receiving unit 810, 920, and a transmitting unit 830, 910, see FIGS. 8 and 9 which may receive and transmit messages and/or signals.

The first communications node 521 is configured to, e.g., by the receiving unit 810 being configured to, receive, from the second communications node 111, the indication of the NN-based AE-decoder model 511-A out of the one or more trained NN-based AE-decoder models 511-A, 111-B.

The first communications node 521 may further comprise a selecting unit 820 which for example may select the AE-encoder model 521-A based on the received indication of the NN-based AE-decoder model 511-A.

The first communications node 521 is configured to, e.g., by the selecting unit 820 being configured to, select the trained NN-based AE-encoder model 521-A out of the one or more trained NN-based AE-encoder models 511-A, 521-B to use for the NN-based AE-encoder based on the received indication of the NN-based AE-decoder model 511-A. In this way that the selected trained NN-based AE-encoder model 521-A is compatible with the indicated NN-based AE-decoder model 511-A.

The first communications node 521 is configured to, e.g., by the transmitting unit 830 being configured to, transmit the CSI to the second communications node 111 based on output from the selected trained NN-based AE-encoder model 521-A.

The first communications node 521 may further be configured to, e.g., by the transmitting unit 830 being configured to, transmit the CSI to the second node 111 over the radio-based air interface 123-UL and using the standardised radio transmission protocol.

In some embodiments the first communications node 521 is further configured to, e.g., by the transmitting unit 830 being configured to, transmit the AE-decoder capability to the second communications node 111 on joining the wireless communications network 100. Then the first communications node 521 may be further configured to, e.g., by the receiving unit 810 being configured to, receive, from the second communications node 111, the decoder configuration comprising the indication to use the AE CSI reporting mode for which the first communications node 121 is configured to use the trained NN-based AE-encoder model 521-A compatible with the indicated NN-based AE-decoder model 511-A.

The second communications node 111 is configured to, e.g., by the transmitting unit 910 being configured to, transmit the indication of the NN-based AE-decoder model 511-A out of the one or more trained NN-based AE-decoder models 511-A, 111-B. The second communications node 511 may be configured to transmit the indication of the NN-based AE-decoder model 511-A to the first communications node 521.

The second communications node 111 is further configured to, e.g., by the receiving unit 920 being configured to, receive the CSI from the first communications node 111 based on output from the trained NN-based AE-encoder model 521-A selected out of the one or more trained NN-based AE-encoder models 521-A, 521-B based on the transmitted indication of the NN-based AE-decoder model 511-A.

The second communications node 111 may further be configured to, e.g., by the receiving unit 920 being configured to, receive the AE-decoder capability from the first communications node 121.

The second communications node 111 may further be configured to, e.g., by the transmitting unit 910 being configured to, transmit, to the first communications node 121, the decoder configuration comprising the indication to use the AE CSI reporting mode for which the first communications node 121 is configured to use the trained NN-based AE-encoder model 521-A compatible with the indicated NN-based AE-decoder model 511-A.

The second communications node 111 may further be configured to, e.g., by the receiving unit 920 being configured to, receive the AE-decoder capability from the first communications node 121 using RRC signalling when the first communications node 111 joins the wireless communications network 100.

The embodiments herein may be implemented through a respective processor or one or more processors, such as the respective processor 804, and 904, of a processing circuitry in the first communications node 521 and the second communications node 511, and depicted in FIGS. 8-9 together with computer program code for performing the functions and actions of the embodiments herein. The program code mentioned above may also be provided as a computer program product, for instance in the form of a data carrier carrying computer program code for performing the embodiments herein when being loaded into the respective first communications node 521 and second communications node 511. One such carrier may be in the form of a CD ROM disc. It is however feasible with other data carriers such as a memory stick. The computer program code may furthermore be provided as pure program code on a server and downloaded to the respective first communications node 521 and second communications node 511.

The first communications node 521 and the second communications node 511 may further comprise a respective memory 802, and 902 comprising one or more memory units. The memory comprises instructions executable by the processor in the first communications node 521 and second communications node 511.

Each respective memory 802 and 902 is arranged to be used to store e.g. information, data, configurations, and applications to perform the methods herein when being executed in the respective first communications node 521 and second communications node 511.

In some embodiments, a respective computer program 803 and 903 comprises instructions, which when executed by the at least one processor, cause the at least one processor of the respective first communications node 521 and second communications node 511 to perform the actions above.

In some embodiments, a respective carrier 805 and 905 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the units described above may refer to a combination of analog and digital circuits, and/or one or more processors configured with software and/or firmware, e.g. stored in the respective first communications node 521 and second communications node 511, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

### Numbered Embodiments

1. A method, performed by a first communications node 121, such as a UE, for providing channel state information, CSI, in a wireless communications network 100, to a second communications node 111, such as radio access node, wherein the first communications node 121 has access to one or more trained Neural Network, NN,-based Auto Encoder, AE,-encoder models 521-A, 521-B for encoding the CSI and the second communications node 111 has access to one or more trained NN-based AE-decoder models 511-A, 111-B for decoding the CSI provided by the first communications node 121, the method comprises:
receiving, from the second communications node 111, an indication of an NN-based AE-decoder model 511-A out of the one or more trained NN-based AE-decoder models 511-A, 111-B;
selecting a trained NN-based AE-encoder model 521-A out of the one or more trained NN-based AE-encoder models 511-A, 521-B to use for the NN-based AE-encoder based on the received indication of the NN-based AE-decoder model 511-A such that the selected trained NN-based AE-encoder model 521-A is compatible with the indicated NN-based AE-decoder model 511-A; and
transmitting, e.g., over the radio-based air interface 123-UL and using a standardised radio transmission protocol, the CSI to the second communications node 111 based on output from the selected trained NN-based AE-encoder model 521-A.

2. The method according to embodiment 1, wherein the indicated NN-based AE-decoder model 511-A is known to the first communications node 121.

3. The method according to any of the embodiments 1-2, wherein the indication of the NN-based AE-decoder model 511-A is received from the second communications node 111 with a CSI reporting configuration.

4. The method according to any of the embodiments 1-3, further comprising:
transmitting an AE-decoder capability to the second communications node 111, for example, using RRC signalling on joining the wireless communications network 100;
receiving, from the second communications node 111, a decoder configuration comprising an indication to use an AE CSI reporting mode for which the first communications node 121 is configured to use the trained NN-based AE-encoder model 521-A compatible with the indicated NN-based AE-decoder model 511-A.

5. The method according to any of the embodiments 3-4, wherein the CSI reporting configuration indicates one or more CSI feedback parameters associated with NN-based AE.

6. The method according to any of the embodiments 3-5, wherein the CSI configuration indicates whether the CSI report shall use periodic PUCCH or aperiodic PUSCH to convey the CSI report to the second communications node 111.

7. The method according to any of the embodiments 4-6, wherein the AE CSI reporting mode is configured with aperiodic CSI reporting.

8. The method according to any of the embodiments 1-7, wherein the indication of the NN-based CSI decoder model is determined by at least a CSI resource configuration used for channel measurement. For example, CSI resource configuration comprises one or more of: a configuration of a number of CSI-RS ports e.g. 16 or 32, of the second communications node 111, a CSI-RS port layout, and an indication of whether the CSI report shall be periodic or aperiodic.

9. A method, performed by a second communications node 111, such as radio access node, for assisting a first communications node 121 in providing channel state information, CSI, to the second communications node 111 in a wireless communications network 100, wherein the first communications node 121 has access to one or more trained Neural Network, NN,-based Auto Encoder, AE,-encoder models 521-A, 521-B for encoding the CSI and the second communications node 111 has access to one or more trained NN-based AE-decoder models 511-A, 111-B for decoding the CSI provided by the first communications node 121, the method comprises:
transmitting an indication of an NN-based AE-decoder model 511-A out of the one or more trained NN-based AE-decoder models 511-A, 111-B; and
receiving, e.g., over the radio-based air interface 123-UL and using a standardised radio transmission protocol, the CSI from the first communications node 111 based on output from a trained NN-based AE-encoder model 521-A selected out of the one or more trained NN-based AE-encoder models 521-A, 521-B based on the transmitted indication of the NN-based AE-decoder model 511-A.

10. The method according to embodiment 9, further comprising:
receiving an AE-decoder capability from the first communications node 121, for example, using RRC signalling when the first communications node 111 joins the wireless communications network 100;
transmitting, to the first communications node 121, a decoder configuration comprising an indication to use an AE CSI reporting mode for which the first communications node 121 is configured to use the trained NN-based AE-encoder model 521-A compatible with the indicated NN-based AE-decoder model 511-A.

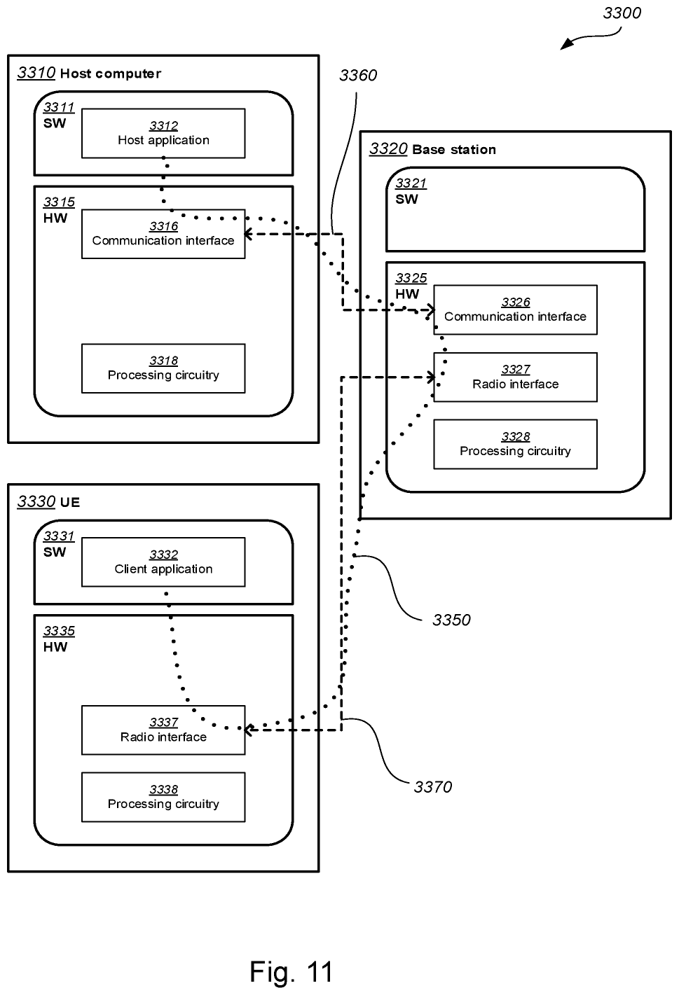

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the source and target access node 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

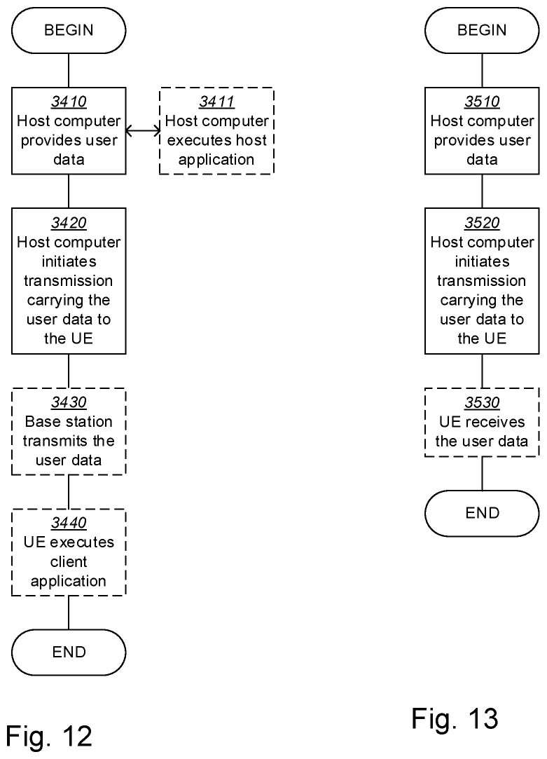

The communication system of FIG. 10 as a whole enables connectivity between one of the connected UEs 3291, 3292 such as e.g. the UE 121, and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230. Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

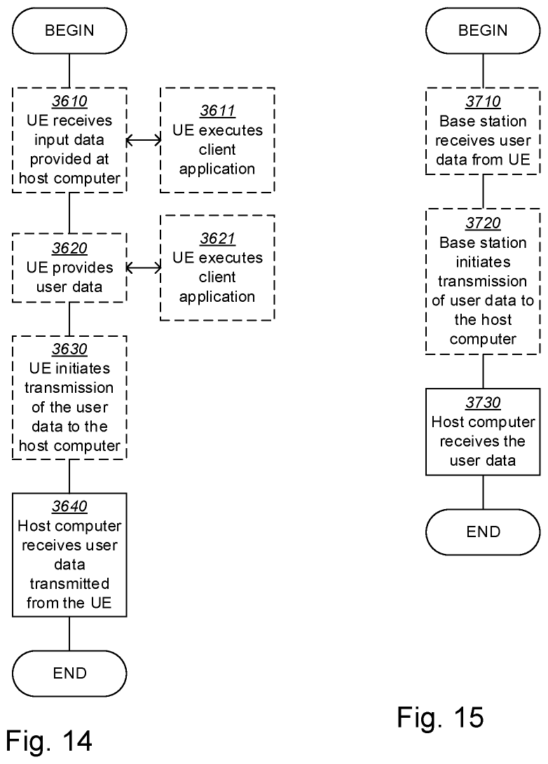

FIG. 12 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 12 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 10 and FIG. 11. For simplicity of the present disclosure, only drawing references to FIG. 14 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station such as a AP STA, and a UE such as a Non-AP STA which may be those described with reference to FIGS. 32 and 33. For simplicity of the present disclosure, only drawing references to FIG. 15 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method, performed by a first communications node, for providing channel state information, CSI, in a wireless communications network, to a second communications node, the first communications node having access to one or more trained Neural Network, NN,-based Auto Encoder, AE,-encoder models for encoding the CSI and the second communications node having access to one or more trained NN-based AE-decoder models for decoding the CSI provided by the first communications node, the method comprising:
receiving, from the second communications node, an indication of an NN-based AE-decoder model out of the one or more trained NN-based AE-decoder models;
selecting a trained NN-based AE-encoder model out of the one or more trained NN-based AE-encoder models to use for the NN-based AE-encoder based on the received indication of the NN-based AE-decoder model such that the selected trained NN-based AE-encoder model is compatible with the indicated NN-based AE-decoder model; and
transmitting the CSI to the second communications node based on output from the selected trained NN-based AE-encoder model.

2. The method according to claim 1, wherein the indicated NN-based AE-decoder model is known to the first communications node.

3. The method according to claim 1, wherein the indication of the NN-based AE-decoder model is received from the second communications node with a CSI reporting configuration.

4. The method according to claim 1, further comprising:
transmitting an AE-decoder capability to the second communications node on joining the wireless communications network; and
receiving, from the second communications node, a decoder configuration comprising an indication to use an AE CSI reporting mode for which the first communications node is configured to use the trained NN-based AE-encoder model compatible with the indicated NN-based AE-decoder model.

5. The method according to claim 3, wherein the CSI reporting configuration indicates one or more CSI feedback parameters associated with NN-based AE.

6. The method according to claim 3, wherein the CSI configuration indicates whether the CSI report shall use periodic PUCCH or aperiodic PUSCH to convey the CSI report to the second communications node.

7. The method according to claim 4, wherein the AE CSI reporting mode is configured with aperiodic CSI reporting.

8. The method according to claim 1, wherein the indication of the NN-based CSI decoder model is determined by at least a CSI resource configuration used for channel measurement.

9. The method according to claim 8, wherein the CSI resource configuration comprises one or more of: a configuration of a number of CSI-RS ports of the second communications node, a CSI-RS port layout, and an indication of whether the CSI report shall be periodic or aperiodic.

10. The method according to claim 1, wherein transmitting the CSI to the second node is performed over a radio-based air interface and using a standardised radio transmission protocol.

11. A method, performed by a second communications node, for assisting a first communications node in providing channel state information, CSI, to the second communications node in a wireless communications network, the first communications node having access to one or more trained Neural Network, NN,-based Auto Encoder, AE,-encoder models for encoding the CSI and the second communications node having access to one or more trained NN-based AE-decoder models for decoding the CSI provided by the first communications node, the method comprising:
transmitting an indication of an NN-based AE-decoder model out of the one or more trained NN-based AE-decoder models; and
receiving the CSI from the first communications node based on output from a trained NN-based AE-encoder model selected out of the one or more trained NN-based AE-encoder models based on the transmitted indication of the NN-based AE-decoder model.

12. The method according to claim 11, further comprising:
receiving an AE-decoder capability from the first communications node; and
transmitting, to the first communications node, a decoder configuration comprising an indication to use an AE CSI reporting mode for which the first communications node is configured to use the trained NN-based AE-encoder model compatible with the indicated NN-based AE-decoder model.

13. The method according to claim 11, wherein receiving the AE-decoder capability from the first communications node is performed using RRC signalling when the first communications node joins the wireless communications network.

14. A computer readable storage medium storing a computer program comprising computer readable code units which when executed on a first communications node causes the first communications node to perform a method for providing channel state information, CSI, in a wireless communications network, to a second communications node, the first communications node having access to one or more trained Neural Network, NN,-based Auto Encoder, AE,-encoder models for encoding the CSI and the second communications node having access to one or more trained NN-based AE-decoder models for decoding the CSI provided by the first communications node, the method comprising:
receiving, from the second communications node, an indication of an NN-based AE-decoder model out of the one or more trained NN-based AE-decoder models;
selecting a trained NN-based AE-encoder model out of the one or more trained NN-based AE-encoder models to use for the NN-based AE-encoder based on the received indication of the NN-based AE-decoder model such that the selected trained NN-based AE-encoder model is compatible with the indicated NN-based AE-decoder model; and
transmitting the CSI to the second communications node based on output from the selected trained NN-based AE-encoder model.

15. (canceled)

16. A first communications node for providing channel state information, CSI, in a wireless communications network, to a second communications node, the first communications node being configured to access one or more trained Neural Network, NN,-based Auto Encoder, AE,-encoder models for encoding the CSI and the second communications node being configured to access one or more trained NN-based AE-decoder models for decoding the CSI provided by the first communications node, wherein the first communications node is configured to:
receive, from the second communications node, an indication of an NN-based AE-decoder model out of the one or more trained NN-based AE-decoder models;
select a trained NN-based AE-encoder model out of the one or more trained NN-based AE-encoder models to use for the NN-based AE-encoder based on the received indication of the NN-based AE-decoder model such that the selected trained NN-based AE-encoder model is compatible with the indicated NN-based AE-decoder model; and
transmit the CSI to the second communications node based on output from the selected trained NN-based AE-encoder model.

17. The first communications node according to claim 16, wherein the indicated NN-based AE-decoder model is known to the first communications node.

18. A second communications node for assisting a first communications node in providing channel state information, CSI, to the second communications node in a wireless communications network, the first communications node being configured to access one or more trained Neural Network, NN,-based Auto Encoder, AE,-encoder models for encoding the CSI and the second communications node being configured to access one or more trained NN-based AE-decoder models for decoding the CSI provided by the first communications node, wherein the second communications node is configured to:
transmit an indication of an NN-based AE-decoder model out of the one or more trained NN-based AE-decoder models; and
receive the CSI from the first communications node based on output from a trained NN-based AE-encoder model selected out of the one or more trained NN-based AE-encoder models based on the transmitted indication of the NN-based AE-decoder model.

19. The second communications node according to claim 18, configured to perform the method, wherein the second communications node is further configured to:
receive an AE-decoder capability from the first communications node; and
transmit, to the first communications node, a decoder configuration comprising an indication to use an AE CSI reporting mode for which the first communications node is configured to use the trained NN-based AE-encoder model compatible with the indicated NN-based AE-decoder model.

20. The first communications node according to claim 16, wherein the first communication node is further configured to:
transmit an AE-decoder capability to the second communications node on joining the wireless communications network; and
receive, from the second communications node, a decoder configuration comprising an indication to use an AE CSI reporting mode for which the first communications node is configured to use the trained NN-based AE-encoder model compatible with the indicated NN-based AE-decoder model.

21. The second communications node according to claim 18, wherein receiving the AE-decoder capability from the first communications node is performed using RRC signalling when the first communications node joins the wireless communications network.
